(19) United States
(12) Patent Application Publication
(10) Pub. No.: US 2013/0076299 A1
(43) Pub. Date: Mar. 28, 2013

(54) CHARGING DEVICE CAPABLE OF AUTOMATICALLY DISTRIBUTING CHARGING CURRENT

(71) Applicant: Wu Chin Chao, New Taipei City (TW)

(72) Inventor: Wu Chin Chao, New Taipei City (TW)

(21) Appl. No.: 13/241,302

(22) Filed: Sep. 23, 2011

(51) Int. Cl. H02J 7/00

(52) U.S. Cl. 320/106

(57) ABSTRACT

The charging device contains a connection unit, a measurement unit, an identification unit, a processing unit, a display unit, a current distribution unit, etc. The connection unit has at last a device connection element for connecting an electronic device. The charging device automatically distributes charging current based on preset parameters and multiple charging devices could be cascaded. As such, all connected electronic devices could be fully charged at high speed under full specification sequentially, and the maximum charging current provided and the number of connected electronic devices is expanded.

### (a) TECHNICAL FIELD OF THE INVENTION

The present invention is generally related to charging devices, and more particularly to a charging device capable of distributing different amounts of charging currents to the connected electronic devices.

### (b) DESCRIPTION OF THE PRIOR ART

As there are more and more portable electronic devices, people are forced to carry more and more charging devices due to the lack of standard. Recently, the USB port has become a common charging interface. However, there are still some disadvantages.

Firstly, if the overall current consumption from multiple charged devices exceeds a threshold, some over-current protection mechanism is activated to stop the charging operation.

Secondly, the threshold limits the maximum charging current and cannot be expanded further.

Thirdly, only a very limited number of devices could be charged and cannot be expanded further.

### SUMMARY OF THE INVENTION

Therefore, a major objective of the present invention is to obviate the shortcoming that a newly added electronic device cannot be charged without unplugging some already-connected electronic devices; because all connected devices including the newly added device consume current that is over the product specification of the charging device.

To achieve the objective, a charging device according to the present invention contains a connection unit, a measurement unit, an identification unit, a processing unit, a power unit, and a current distribution unit. The connection unit connects a number of electronic devices. The identification unit identifies the identification data or electrical characteristics of the electronic devices connected to the connection unit. The measurement unit measures the amounts of charging currents provided by the connection unit to the electronic devices. The processing unit, based on the identification data and individual current measurement, determines appropriate charging mode data compatible to the electronic devices, records the current charging modes of the electronic devices as individual registration data, and issues current distribution command in accordance with the charging mode data, registration information, and preset charging policy data. The current distribution unit, following the charging policy data, conducts charging to the electronic devices and the total current consumption will not exceed a preset maximum current amount. When a charging current varies, the processing unit automatically adjusts the charging modes to the electronic devices according to the registration information so as to achieve automatic current distribution.

Additionally, the charging device contains a communication interface unit connected to the processing unit for cascading another charging device. The cascading charging devices, in accordance with the communication protocol of the communication interface units, jointly determines a master-slave hierarchy for expanding the amount of charging current and the number of electronic devices that could be charged.

With the foregoing structure, the charging device of the present invention is able to obviate the shortcoming that the maximum charging current is limited and cannot be expanded further.

With the foregoing structure, the charging device of the present invention is able to obviate another shortcoming that only a very limited number of devices could be fully charged and some are half charged and some are wait to be charged and cannot be expanded further.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a charging device according an embodiment of the present invention.

FIG. 2 is another functional block diagram showing a charging device according to an embodiment of the present invention.

FIG. 2a is a first partially enlarged functional block diagram showing the charging device of FIG. 2.

FIG. 2b is a second partially enlarged functional block diagram showing the charging device of FIG. 2.

FIG. 2c is a third partially enlarged functional block diagram showing the charging device of FIG. 2.

FIG. 3 is yet another functional block diagram showing a charging device according to an embodiment of the present invention.

FIG. 3a is a first partially enlarged functional block diagram showing the charging device of FIG. 3.

FIG. 3b is a second partially enlarged functional block diagram showing the charging device of FIG. 3.

FIG. 3c is a third partially enlarged functional block diagram showing the charging device of FIG. 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

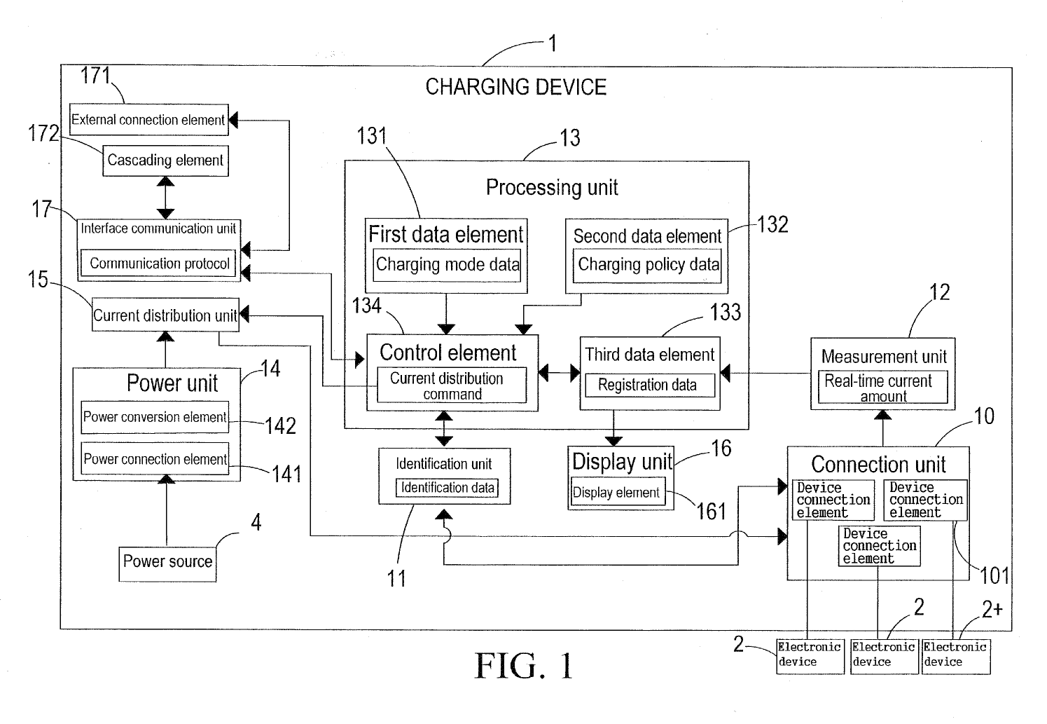

As shown in FIGS. 1 to 3, a charging device according to an embodiment of the present invention contains a connection unit 10, a measurement unit 12, an identification unit 11, a processing unit 13, a display unit 16, a current distribution unit 15, a communication interface unit 17, at least an external connection element 171 and a cascading element 172.

The connection unit 10 contains at least a device connection element 101 for connecting at least an electronic device 2. The measurement unit 12 is connected to the connection unit 10 and measures the real-time current amount provided by the connection unit 10 to the electronic devices 2. The identification unit 11 is also connected to the connection unit 10 and identifies each electronic device 2's identification data of preset electrical characteristics.

The connection unit 10, the identification unit 11, and the measurement unit 12 are all connected to the processing unit 13, which contains a first data element 131, a second data element 132, a third data element 133, and a control element 134. The first data element 131 stores the charging mode data for various electronic devices 2, which involves the amount of charging current and related control method under fast charging mode, slow charging mode, charging under usage mode, and wait-for-charging mode for various electronic devise 2. The second data element 132 stores the data for a number of charging policies, each involving the parameters for the charging modes, weighting factors or priorities, and cascading time sequence. The third data element 133 stores registration information for various electronic devices 2 individually. The registration information of the third data element 133 is parameterized from the charging policies and is recorded with the measurement results made by the measurement unit 12 for various electronic devices individually. The control element 134 receives the identification data, locates the corresponding charging mode data by the recorded registration information, and issues a current distribution command in accordance with the corresponding charging policy in real time.

The current distribution unit 15 is connected between the processing unit 13 and the connection unit 10, and is also connected to a power unit 14 which provides the charging current. The power unit 14 contains a power connection element 141 connected to a power source 4 and a power conversion element 142 connected between the power connection element 141 and the current distribution unit 15. The power conversion element 142 transforms the electricity received by the power connection element 141 from the power source 4 into appropriate forms for the device connection elements 101. The current distribution unit 15, following the current distribution command, conducts charging to the electronic devices 2, and the total charging current is controlled to be within a maximum current amount.

The display unit 16 contains a number of display elements 161 connected to the processing unit 13. Depending on the current registration information, the display elements 161 show the charging modes of the various device connection elements 101.

The communication interface unit 17, configured with a communication protocol, is connected to the processing unit 13 and at least an external connection element 171. Each external connection element 171 provides information such as its charging mode data and communication protocol etc. The control element 134 of each charging device 1 therefore is able to compare the charging mode data and program versions, automatically updates charging mode data and program code of a new version into those of the latest, and establishes a master-slave charging current distribution mechanism. An external connection element 171 could be connected to a computer 3 and transmits the real-time charging mode data and measured data for each electronic device 2 to the computer 3. The communication interface unit 17 could be further connected to a cascading element 172 which is in turn connected an external connection element 171 of another identically-structured charging device 1. The charging devices 1 jointly determine a master-slave hierarchy following the communication protocol and distribute the charging currents of the charging devices 1 to the various device connection elements 101. A number of application scenarios of the charging device 1 are described as follows.

In the first scenario as shown in FIG. 1, an electronic device 2+ is newly connected to the connection unit 10, in addition to the already connected electronic devices 2 under charging. The processing unit 13 determines if the maximum current amount would be exceeded. If yes, according to the charging policy data, including the parameters for the charging modes, weighting factors or priorities, and cascading time sequence, the processing unit 13 issues a current distribution current conforming to the current amounts and control methods of various electronic devices 2 and 2+ under the fast charging, slow charging, and wait-for-charging modes so that all connected electronic device 2+ could be charged at different times without exceeding the maximum current amount.

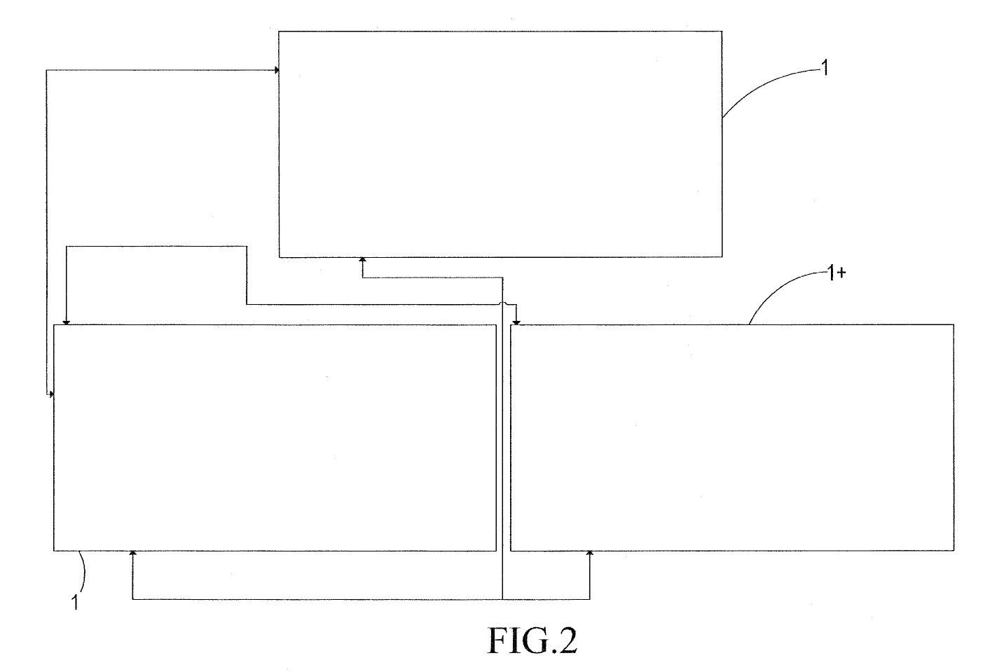

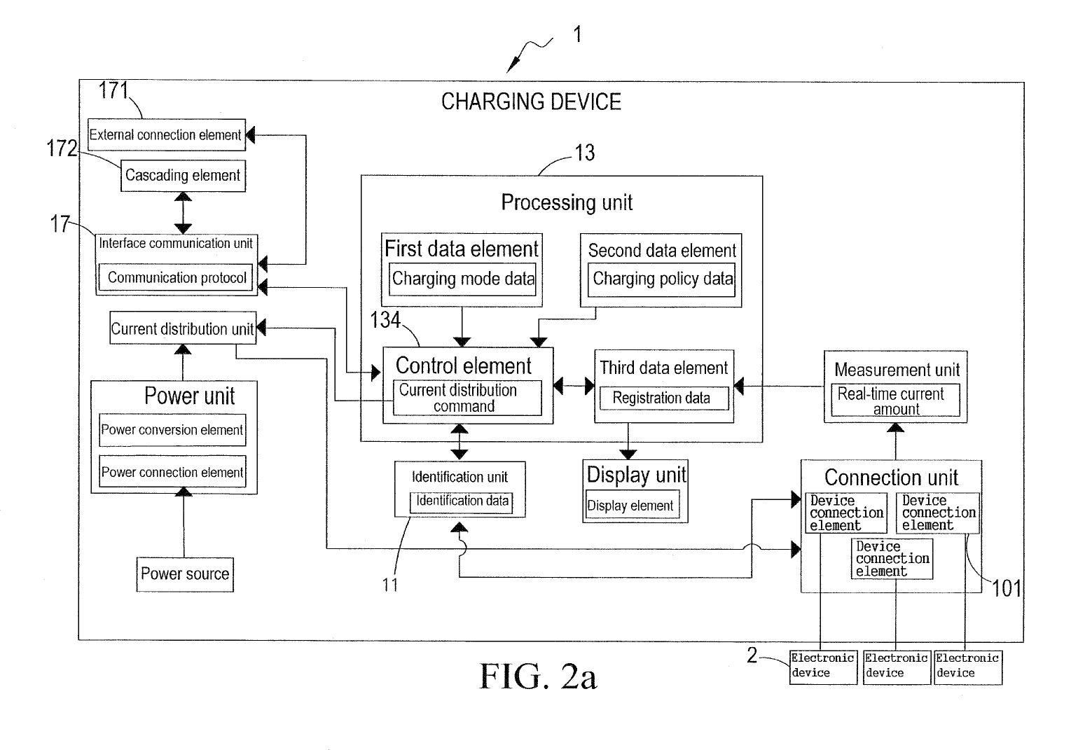

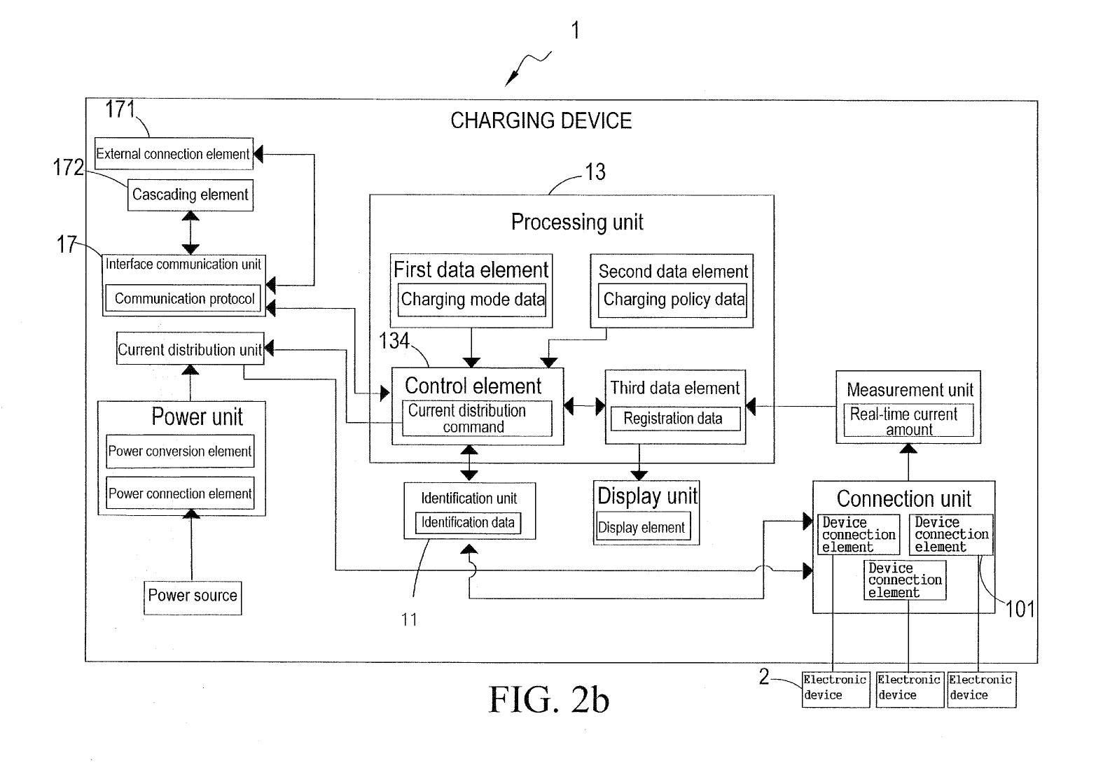

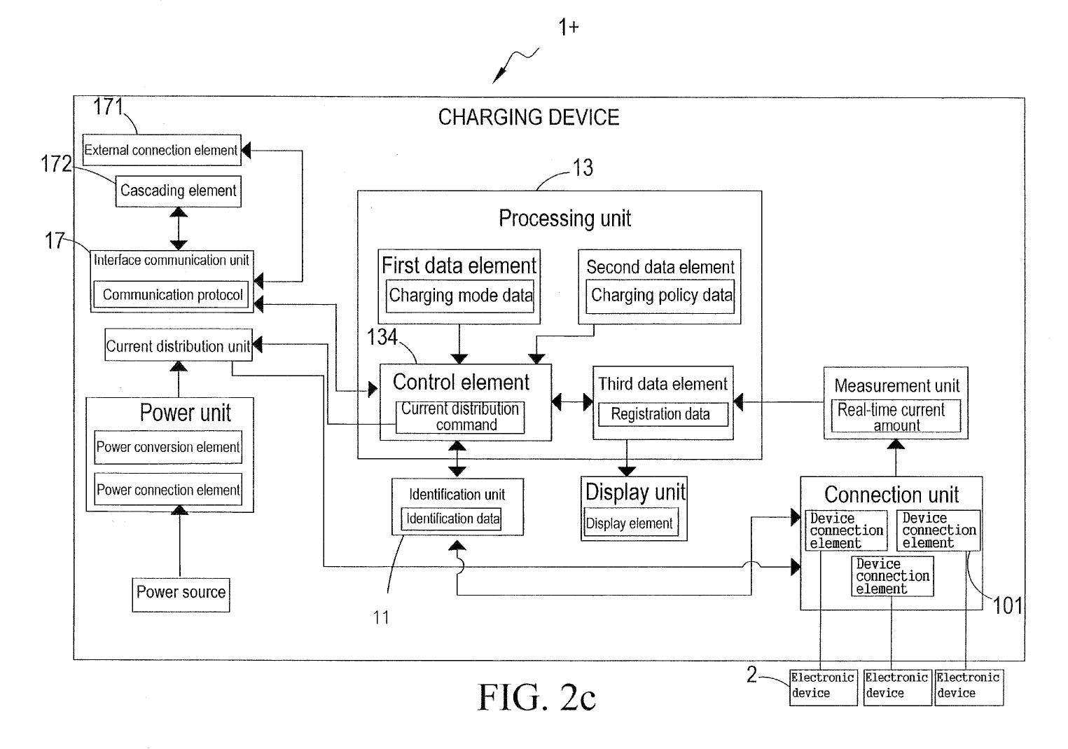

In the second scenario as shown in FIG. 2, as well as FIGS. 2a, 2b, and 2c which are partially enlarged diagrams, an additional charging device 1+ is cascaded to already-cascaded charging devices 1. As illustrated, the power units 14 of the charging devices 1 and 1+ are electrically connected together. Each charging device 1 or 1+ has a communication interface unit 17, configured with a communication protocol and connected to the processing unit 13 and the current distribution unit 15. The communication interface unit 17 is connected to at least an external connection element 171. Each external connection element 171 provides information such as its charging mode data and communication protocol etc. so that the control element 134 is able to compare the charging mode data and program versions, and automatically updates charging mode data and program version into those of the latest. The communication interface unit 17 could be further connected to a cascading element 172 which is in turn connected an external connection element 171 of the newly added charging device 1+. The charging devices 1 and 1+ jointly determine a master-slave hierarchy and distribute the charging currents of the charging devices 1 to the various device connection elements 101. When the charging device 1+ is cascaded, the master-slave relationship with other charging devices 1 is determined first by their program versions. The one with the older version is updated to the new version following the communication protocol. If the charging devices 1 and 1+ have identical program version, the master-slave relationship is determined by their cascading time sequence or charging current capability or number of charging connection port. Then, the processing unit 13 of a master charging device 1, according to the charging policy data which includes the parameters for the charging modes, weighting factors or priorities, and cascading time sequence, issues a current distribution current conforming to the current amounts and control methods of various electronic devices 2 under the fast charging, slow charging, and wait-for-charging modes. The charging currents from all charging devices 1 and 1+ are altogether distributed among the electronic devices 2. As such, the number of device connection elements 101 is expanded and all electronic devices 2 are distributed with an appropriate amount of charging current.

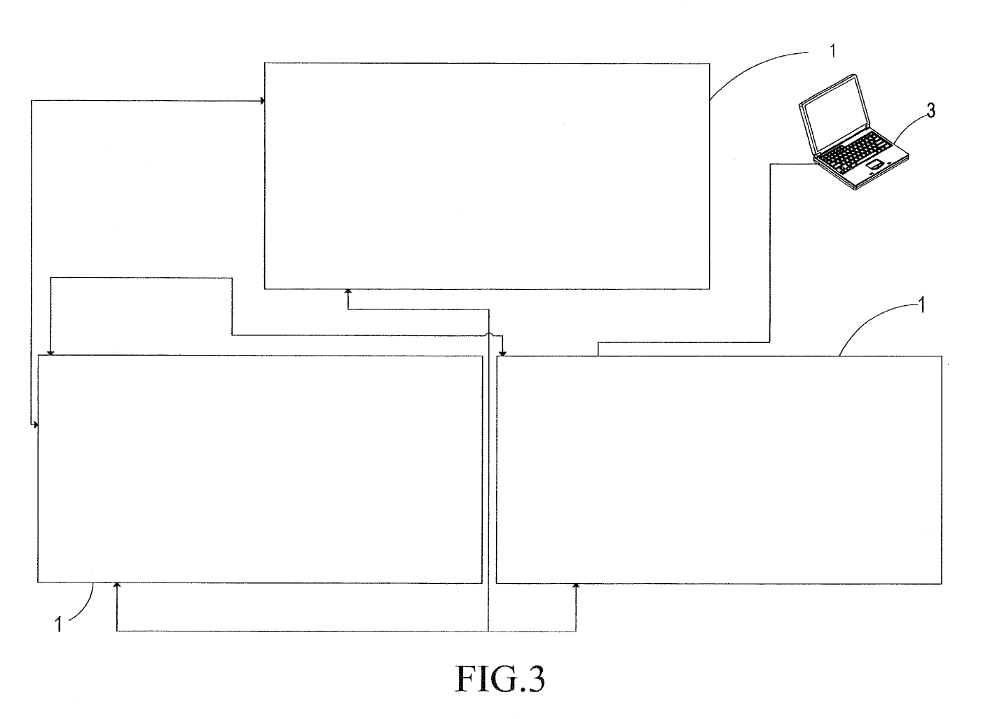

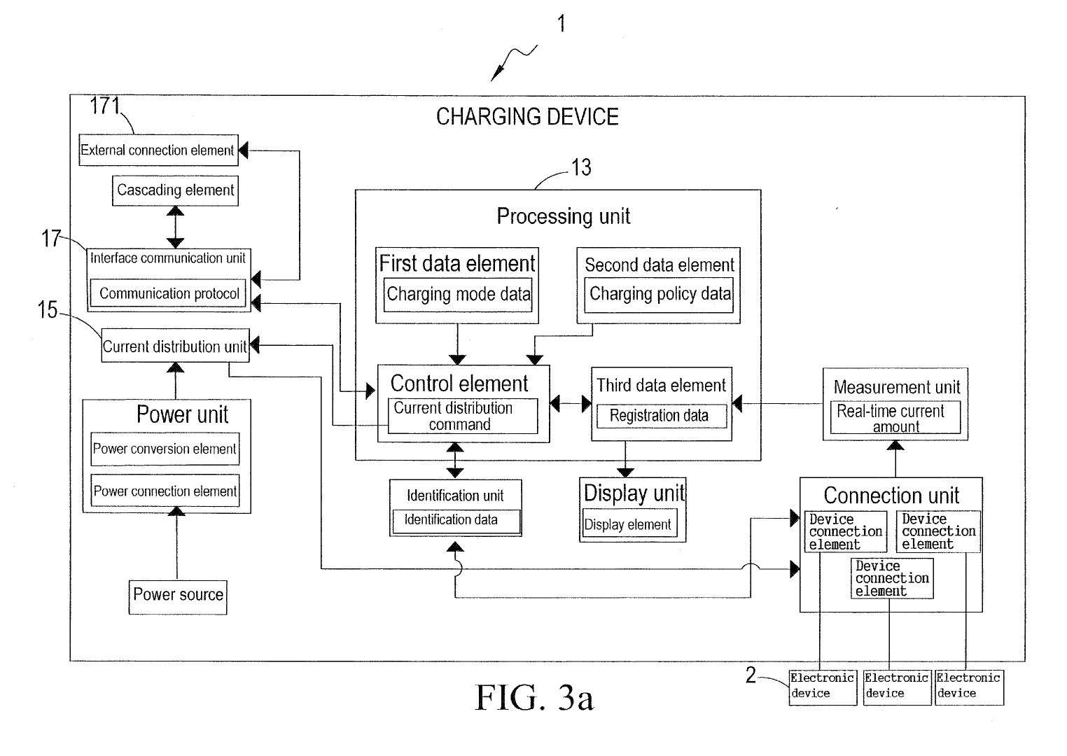

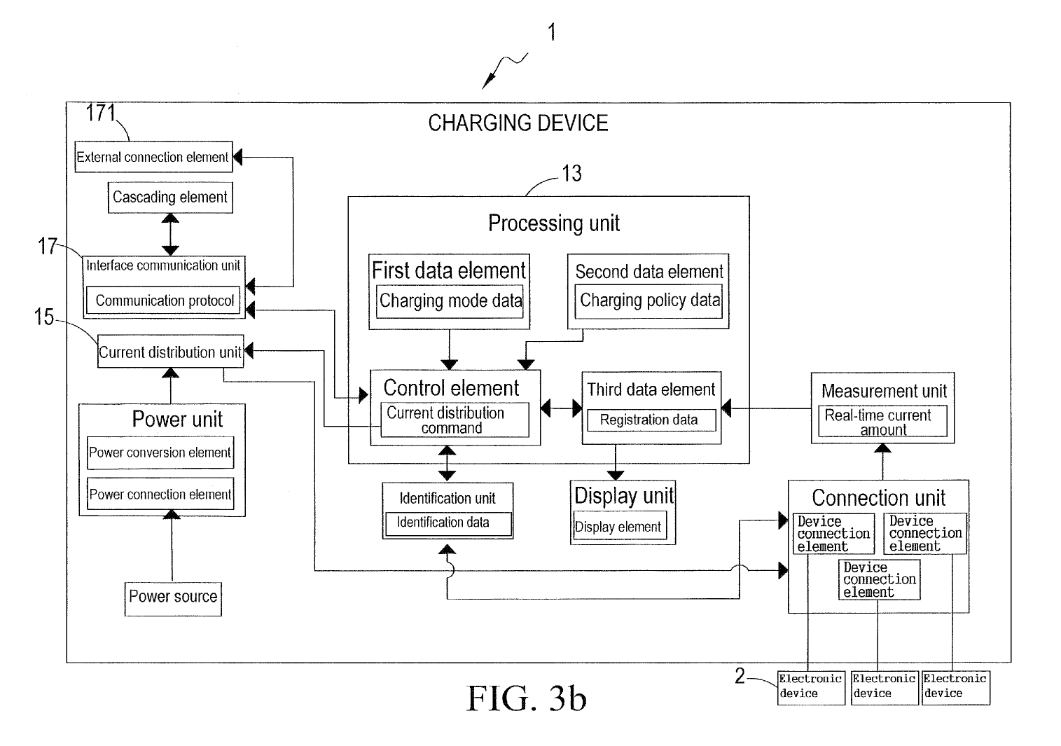

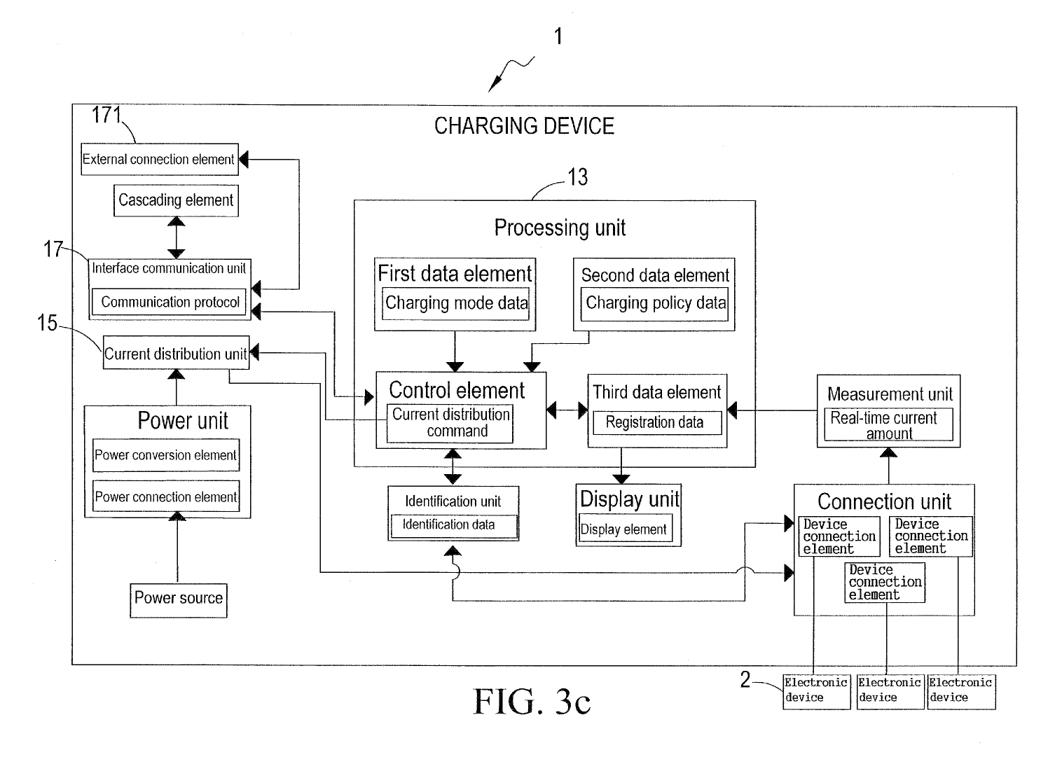

In the third scenario as shown in FIG. 3, as well as FIGS. 3a, 3b, and 3c which are partially enlarged diagrams, a computer 3 is connected to one of a number of cascaded charging devices 1. As illustrated, the power units 14 of the charging devices 1 are electrically connected together. Each charging device 1 has a communication interface unit 17, configured with a communication protocol and connected to the processing unit 13. The communication interface unit 17 is connected to at least an external connection element 171 which is in turn connected to the identification unit 11. An external connection element 171 could be connected to a computer 3 and transmits the charging mode data and real-time measured data for each electronic device 2 to the computer 3.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A charging device, comprising:
a connection unit having at least a device connection element for connecting at least an electronic device;
a measurement unit connected to said connection unit measuring a real-time current amount supplied by said connection unit to each of said electronic devices;
an identification unit connected to said connection unit identifying an identification data of electrical characteristics for each of said electronic devices;
a processing unit connected to said connection unit, identification unit, and measurement unit, said processing unit registering said identification data, built-in charging mode data, and said real-time current amount for each of said electronic devices as a registration information and issuing a current distribution command involving built-in charging policy data; and
a current distribution unit connected to said processing unit, said connection unit, and a power unit capable of supplying a maximum current amount, said current distribution unit, based on said current distribution command, conducting charging to said electronic devices so that total charging current does not exceed said maximum current amount.

2. The charging device according to claim 1, wherein said processing unit further comprises:
a first data element storing charging mode data for said electronic devices;
a second data element storing data for a plurality of charging policies, each involving parameters for charging modes, weighting factors or priorities, and cascading time sequence;
a third data element transforming measurement result from said measurement unit into corresponding registration information for said electronic devices' charging modes; and
a control element receiving identification data, locating corresponding charging mode data by registration information, and issuing a current distribution command in accordance with corresponding charging policy.

3. The charging device according to claim 1, wherein said charging mode data contains the amount of charging current and related control method under fast charging mode, slow charging mode, and wait-for-charging mode for each of said electronic devices.

4. The charging device according to claim 1, wherein said power unit further comprises:
a power connection element electrically connected to a power source; and
a power conversion element connected between said power connection element and said current distribution unit, said power conversion element transforming the electricity received by said power connection element from said power source into appropriate forms for said device connection elements.

5. The charging device according to claim 1, further comprising a display unit connected to said processing unit, said display unit comprising a plurality of display element.

6. The charging device according to claim 5, wherein each of said display elements shows a current charging mode of a corresponding device connection element.

7. The charging device according to claim 1, further comprising:
a communication interface unit configured with a communication protocol and connected to said processing unit and said current distribution unit;
at least an external connection element connected to said communication interface unit; and
a cascading element connected to said communication interface unit for connecting an external connection element of another identically-structured charging device;
wherein said cascaded charging devices jointly determine a master-slave hierarchy following said communication protocol and distribute the charging currents of said charging devices to said device connection elements.

8. The charging device according to claim 7, wherein said external connection elements from cascaded charging devices provide information about charging mode data and communication protocol to each other; said control element of each charging device therefore is able to compare said charging mode data and program versions, and automatically update charging mode data and program version into those of the latest.

9. The charging device according to claim 8, wherein said external connection element is connected to a computer and transmits said charging mode data and communication protocol for said electronic devices to said computer.
